(19) United States
(12) Patent Application Publication
(10) Pub. No.: US 2003/0059194 A1
(43) Pub. Date: Mar. 27, 2003

(54) Multi axis component actuator

(76) Inventor: Mike Trzecieski, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/254,584

(22) Filed: Sep. 26, 2002

Related U.S. Application Data
(60) Provisional application No. 60/324,545, filed on Sep. 26, 2001.

(51) Int. Cl. G02B 6/38; G02B 6/00

(52) U.S. Cl. 385/137; 385/57

(57) ABSTRACT

A three axis optical component actuator mechanism is disclosed using two electromagnetic coil actuators and a common stator assembly. In the preferred embodiment the optical component is coupled to the carriage and the carriage is controllable in two axes using electromagnets. A third axis is controllable using a linear motor. The carriage is resiliently mounted within the stator assembly with a plurality of magnetic flux air gaps defined within. Advantageously the disclosed three-axis optical component actuation mechanism has a high frequency response as well as inexpensive cost of manufacturing. In an alternative embodiment a three axis electromagnetic coil actuator is shown having precise travel without the need for expensive linear bearing assemblies.

This application claims priority from Provisional Application No. 60/324,545 filed Sep. 26, 2001.

### FIELD OF THE INVENTION

This invention relates to the field of fiber optic component assembly and more specifically to the area of a fast actuator for use in the alignment of fiber optic components.

### BACKGROUND OF THE INVENTION

The basic building blocks behind the fiber optic internet are optical network components, many of which internally use simple components such as lenses, filters, optomechanical parts and waveguide structures.

For a fiber optical component (FOC) to be useable in an optical communication system at some point at least one fiber, usually an input fiber, must be attached to the FOC. During the assembly of FOCs at some point the light needs to be at least one of coupled into and out of the FOC in order for the FOC to be useable in a fiber optic communication network. Coupling of light into the FOC is accomplished via an optical fiber, which is aligned to a port on the FOC in order to deliver a predetermined amount of optical intensity into the FOC; and the light coming out of the FOC is aligned to an output fiber, or in the case of a multi-port device, output fibers.

Coupling of an optical fiber to the FOC require a positioning mechanism for actively aligning of the fiber relative to the FOC. Typically this type of mechanism allows for translational motion of optical fiber in three orthogonal directions. For each axis, translating that axis results in the optical power changing as the coupling of light changes between the fiber and the FOC in response to the movement of the fiber.

Typically during the process of aligning a FOC in three axis the Z-axis determines the focusing of the optical system and the X and Y directions ensure capturing of the light as the fiber is brought physically closer to the FOC during active alignment.

During active alignment an axis becomes optimally aligned when translation in either direction from this optimum point results in the detected optical power coupling into, or out of the FOC to decrease.

Upon optimizing of a single axis in this manner the procedure is repeated for all the other axes, until such a point is reached where all axes are optimally aligned. This operation is typically performed by a human operator actuating knobs to move the fibers.

Conventional means of coupling fibers to FOCs utilize expensive high precision mechanical 3 axis positioning stages. Typically, these positioning stages offer high precision, high repeatability, high rigidity. The majority of these positioning stages utilize high precision roller bearings on precision ground hardened steel rails. Moving of the axes within the positioning stage is accomplished by actuating sub micron resolution micrometers for each of the axes. Coupling springs in a variety of orientations tightly hold the positioning stage together to take up any form of mechanical tolerance within the positioning stage mechanics so that the inaccuracies in the mechanics does not aversely affect performance during optical alignment. These stages are very precise and any orthogonal error to in an axis during movement is unnoticed. In order to provide sub micron accuracy, each of the stages is built in a very robust manner. This helps to reduce low frequency vibration. Unfortunately, this also results in very heavy assembly units that support arrays of stages.

For these precision stages to be useful in an optical alignment setup, it is required that optical alignment setup be somehow dampened from external vibrations. Typically the FOC and positioning stages are rigidly fixed to an optical table. Optical tables are large rectangular structures made from steel plates with holes drilled on the upper surface for mounting of positioning stages as well as FOCs. These drilled surfaces are made to be very flat. In some cases these optical tables are mounted to floating leg assemblies to further dampen any vibrations that may be present in the floor so that these vibrations do not adversely affect the alignment process. Because of the sheer weight of these tables they offer good vibration compensation for the optical alignment setup, however have an added expense of weight, sized and cost.

Not to mention that if a table needs to be moved from one lab space to another, heavy lifting equipment is often required. Therefore in times of expansion or cut back in a company, when equipment needs to be moved, these tables pose a large inconvenience. Additionally, when tables like this are moved the positioning stages are typically removed, relocated and reassembled. Optical breadboards are an alternate solution to optical tables, however typically they also require some form of vibration isolation during an optical alignment procedure.

In some cases, assembly of FOCs is accomplished by using non-human means. In this case motorized actuators take the place of fingers moving knobs. A feedback signal indicative of the optical alignment of the fibers in relation to the FOC is generated in response to the motorized movement of external inputs on the positioning stages.

Motors utilized for these stages may either take the form of rotary actuators or linear actuators. Rotary actuators typically have rotary encoders on armature ends to count pulses in order to provide a feedback signal indicative of how many rotations were made. Rotary actuators are typically either DC motor based or stepper motor based. With a stepper motoer a rotary encoder is not necessary since the rotation angle the stepper motor is proportional to the applied pulses. Stepper motors however are more expensive than DC motors coupled to shaft encoders. Of course, in order to achieve any form of precision with either rotary actuator, the rotor must be coupled to a gear box for speed reduction and to some form of a lead screw and thread mechanism. All of which lead to quite expensive, heavy and bulky positioning stage actuator mechanics.

In order to reduce the number of mechanical components required within a positioning stage, manufacturers offer linear positioning stages. Within a linear positioning stage, such as that offered by Aerotech Inc., are a series of magnetic coils and fixed magnets forming a linear stepper motor. The linear stepper translates an axis of the actuator in response to a series of parallel pulses provided to the windings of the linear motor. Again, since a stepper motor is used, complicated control electronics are also employed in order to obtain precision alignment of light coupled into or out of the FOC.

Piezoelectric actuators are also offered as actuators within linear positioning stage to precise provide motion. These actuators require high voltages, typically around 150V, and their controllable displacement is function of their mechanical length. For example if 150 V is applied to a 10 mm actuator about 0.1 mm of travel results. Position feedback is afforded by the change in capacitance as the actuator elongates. Again, using a feedback mechanism involves adding complicated control electronics to obtain precision alignment of light coupled into or out of the FOC.

In fiber optic network component assembly it is preferable to have an actuator mechanism that is capable of precisely positioning the optical component at high speeds. It is also preferable to have a multi-axis actuator that is inexpensive such that the overall cost of purchasing and maintenance does not adversely affect profit margins. A system developed around electromagnetic coil actuators is ideal since these actuators are inexpensive to manufacture and require simpler control. Voice coil actuators have replaced stepper motors in hard drives because of the speed afforded by the voice coil as well as reduced manufacturing costs.

To one skilled in the art at the time it is apparent that the current fiber optic component automation industry uses big, bulky, expensive, automated positioning stages to align FOCs. FOCs are small, precise, and low weight. Therefore using non-rigid electromagnetic actuators is ideal in aligning FOCs because of speed and precision, unfortunately the benefits gained from using such an actuator also result in an increased susceptibility to external forces. A trade off exists between quality of alignment, speed, and vibration. Such an actuator is susceptible to external forces, has a compact size, and is relatively inexpensive, all of which are quite contrary to that which is taught by the prior art.

It is therefore an object of the present invention to provide a three axis actuator system for precision alignment of an optical fiber to a FOC that overcomes the deficiencies of the prior art.

### SUMMARY OF THE INVENTION

In accordance with the invention there is provided a three axis controllable component actuator comprising: a magnetic stator assembly having permanent magnets disposed therein and having a magnetic yoke assembly with a gap therebetween having magnetic flux therein; a carriage having electromagnetic coils wound around a first central and around a second central axis, the carriage flexibly mounted to the magnetic stator assembly with a portion of the electromagnetic coils disposed within the gap to permit controllable displacement of the carriage along at lease one of the first and the second axis in response to electric current flowing in the electromagnetic coils interacting with the magnetic flux within the gap; and, a linear actuator coupled to the magnetic stator assembly for moving the magnetic stator assembly in a substantially orthogonal direction in relation to the first and second axes.

In accordance with an aspect of the invention there is provided a component actuator comprising:

a first linear actuator having a first stator and a first actuatable shaft, the first actuatable shaft for being displaced in a direction along a first axis and with a distance in proportion to a first control signal having a polarity and a magnitude and applied to the first linear actuator; a first magnet coupled to the first actuatable shaft; and, a carriage magnetically coupled to the first magnet and other than fixedly coupled to the first linear actuator, for, in use, moving along an axis substantially parallel to the first axis in dependence upon the first control signal.

### BRIEF DESCRIPTION OF THE DRAWINGS

The invention will now be described with reference to the drawings in which:

FIG. 1 is a perspective view of a prior art CD player lens focusing and tracking mechanism (FTM);

FIG. 2 is a diagram of an electromagnetic controllable dual axis mechanism (ECM), similar to the FTM, coupled to a linear actuator;

FIG. 3 is a perspective view showing the ECM coupled to a linear slide and a linear motor for use in a component alignment system;

FIG. 4 is illustrates angular calibration of the ECM;

FIG. 5 illustrates a reflective optical intensity positional calibration system for the carriage of the ECM;

FIG. 6 shows a plurality of ECMs positioned with a common axis for aligning a plurality of components to each other; and,

FIGS. 7a and 7b illustrate an alternative embodiment of a three axis component actuators actuated using linear actuators.

### DETAILED DESCRIPTION OF THE INVENTION

In the below description directions are arbitrarily selected and are indicated as directions of travel parallel to an axis for linear axes and rotating about an axis for axes of rotation.

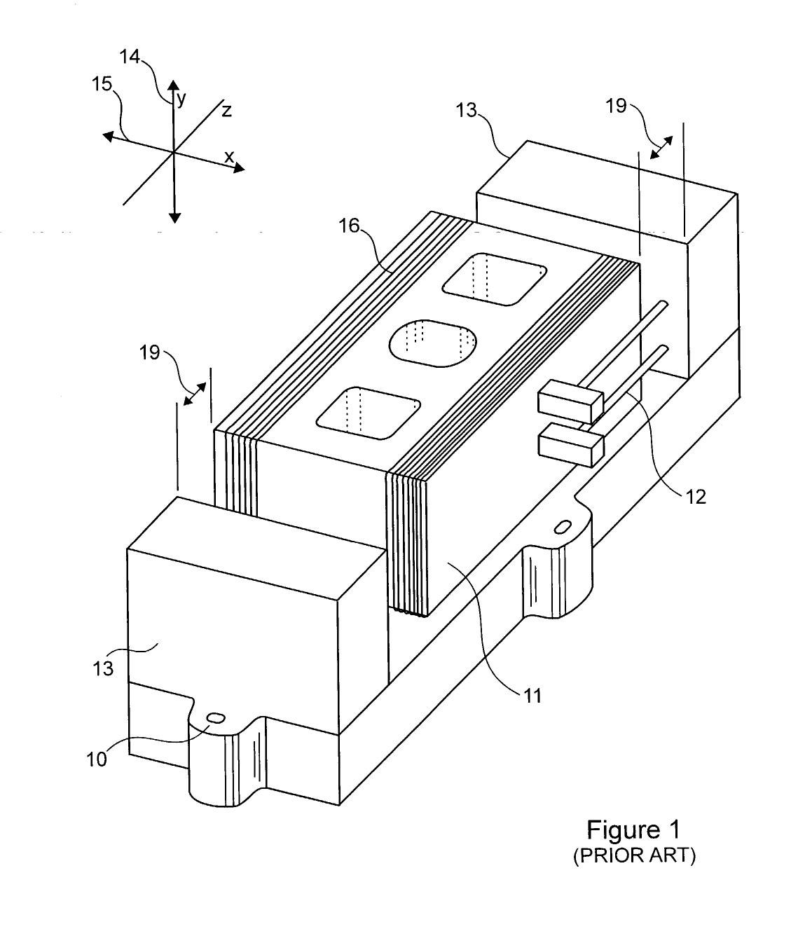

Referring to FIG. 1, a prior art CD player focus and tracking mechanism (FTM), is shown. The FTM comprises a magnetic stator assembly 10, having a magnetic yoke and having two magnets 13 disposed thereon, a carriage 11, mounting wires 12. The mounting wires 12 for flexibly mounting the carriage to the stator assembly as well as for conducting current to the electromagnetic windings 16 as part of the carriage 11. A gap 19 is formed between the magnets 13 and the magnetic yoke, the gap 19 having magnetic flux therein. With no current applied to the electromagnetic windings 16, the carriage is supported within the gap 19 using mounting wires 12 in such a manner that it does not touch the magnetic stator assembly 10. Furthermore, the carriage 11 is spatially oriented by the mounting wires 12 within the gap 19 in such a manner so as to be able to be displaced proportionately in two substantially orthogonal axes upon the application of a control signal having a polarity and magnitude. In response to the control signal, the carriage linearly displaces proportionately to the applied control signal as the current in the coils reacts with the magnetic flux within the gap 19. Thus, controllable motion of the carriages 11 is obtainable in the two substantially orthogonal axes. Namely, controllable horizontal displacement along an X direction 15, as well as controllable displacement in a vertical, Y direction 14. Unfortunately, the FTM assembly has no provision for controllable motion along the Z direction. In use within a CD player the FTM is mounted to a third motorized axis, in such an orientation that this third axis is parallel to one of the controllable axes of the FTM. Meaning, that unfortunately the device is unsuitable for three axis alignment since it lacks controllable motion along a third controllable axis that is oriented orthogonal to the X direction axis and the Y direction axis.

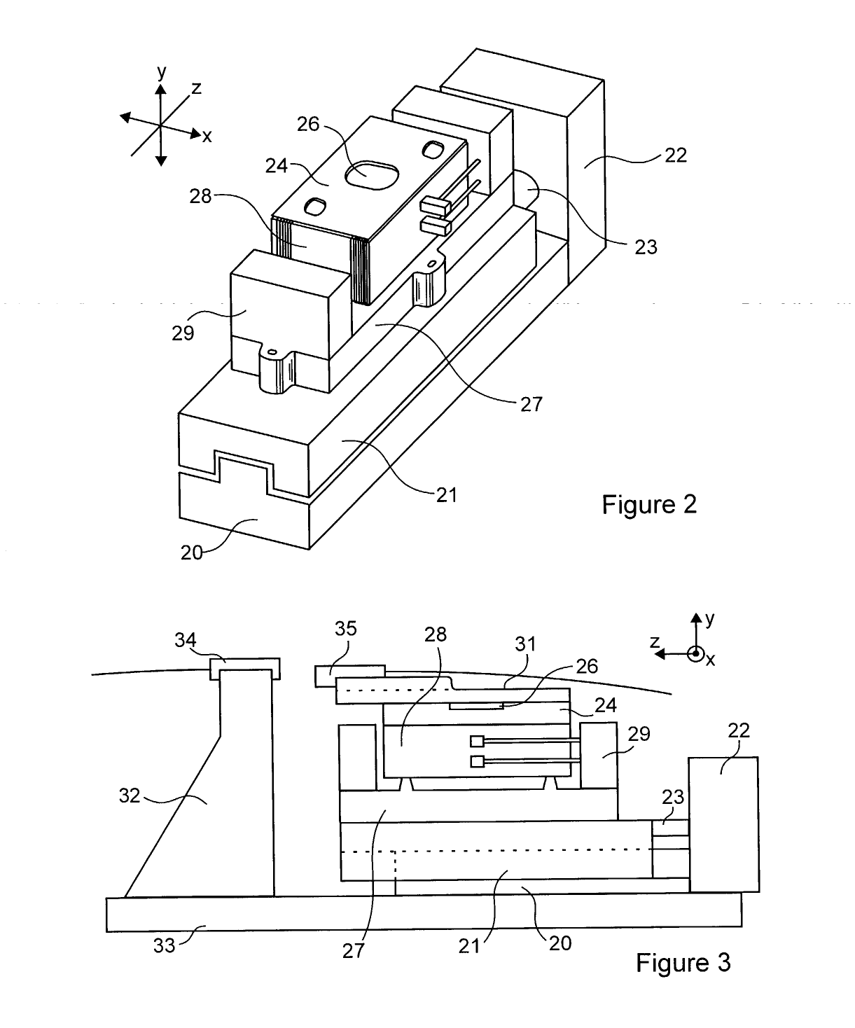

In FIG. 2, an electromagnetic controllable dual axis mechanism (ECM) 29, similar to the FTM of prior art FIG. 1, is shown. The ECM 29 has two substantially orthogonal electromagnetically actuated axes of displacement that displace a carriage 28 relative to a stator portion 27 of the ECM 29. The stator assembly having a magnetic yoke with the magnets coupled therewith to permit a magnetic flux to reside in a gap therebetween. Electromagnetic coils coupled to the carriage have a portion thereof located within this gap. The stator portion 27 of the ECM 29 is coupled to a sliding portion 21 of a linear actuator bearing slider assembly 20 and 21. The stator portion 20 of the bearing slider assembly is fixedly mounted to a plate 33 (FIG. 3). A linear actuator 22 is coupled to the stator portion 20 of the bearing slider in such a manner that upon receiving a control signal the linear actuator 22 slides the sliding portion 21 on bearing provided within the bearing slider assembly 20 and 21 in response thereto, resulting in displacement of the ECM 29 along an axis substantially orthogonal to the electromagnetically actuated axes of displacement of the ECM 29. In use, when a control signal is applied to the windings of each of the coils wound about the carriage, a magnetic field is generated that interacts with the magnetic flux in the gap, resulting in movement of the carriage in response thereto.

A variation of the embodiment shown in FIG. 2 is shown in FIG. 3. In this case similarly to that shown in FIG. 2. The ECM 29 is coupled to a linear actuator 22 in an orientation such that the resultant two electromagnetically actuated axes of displacement are substantially orthogonal to the axis of the linear actuator 22.

In use, the linear actuator 22 moves the slider assembly 21 along a Z direction in response to a control signal applied to the linear actuator 22 by a control circuit. Two optical components 34 and 35 are held by component holders 32 and 31, wherein component holder 32 is stationary with respect to all axes of travel of the component holder 31. Component holder 31 is coupled to the carriage 28 of the ECM 29. It is therefore preferable to orient the optical component 35 on the mounting plate 24 of the ECM 29 in such a manner that the axes of the optical component 35 which require precise travel are those which are mounted parallel to the electromagnetically controllable axes of the ECM 29, the third axis thus being utilized for coarse positioning of optical component 35 with respect to optical component 34.

Optionally, component holder 31 is coupled to the mounting plate with a small magnet 26 embedded within the carriage 28 for magnetically attracting a metallic portion of the component holder 31. The mounting plate allows for various component holders 31 to be removably mounted to the carriage 28. Preferably, precision alignment marks on both the mounting plate and component holders allow for repeatable positioning of the component holders. The orientation of the magnet 26 within the carriage 28 is advantageously provided in such a manner as to oppose the magnetic flux generated by the stator assembly 27, thereby reducing a portion of the weight imposed on the carriage 28 by the optical component 35 when in use.

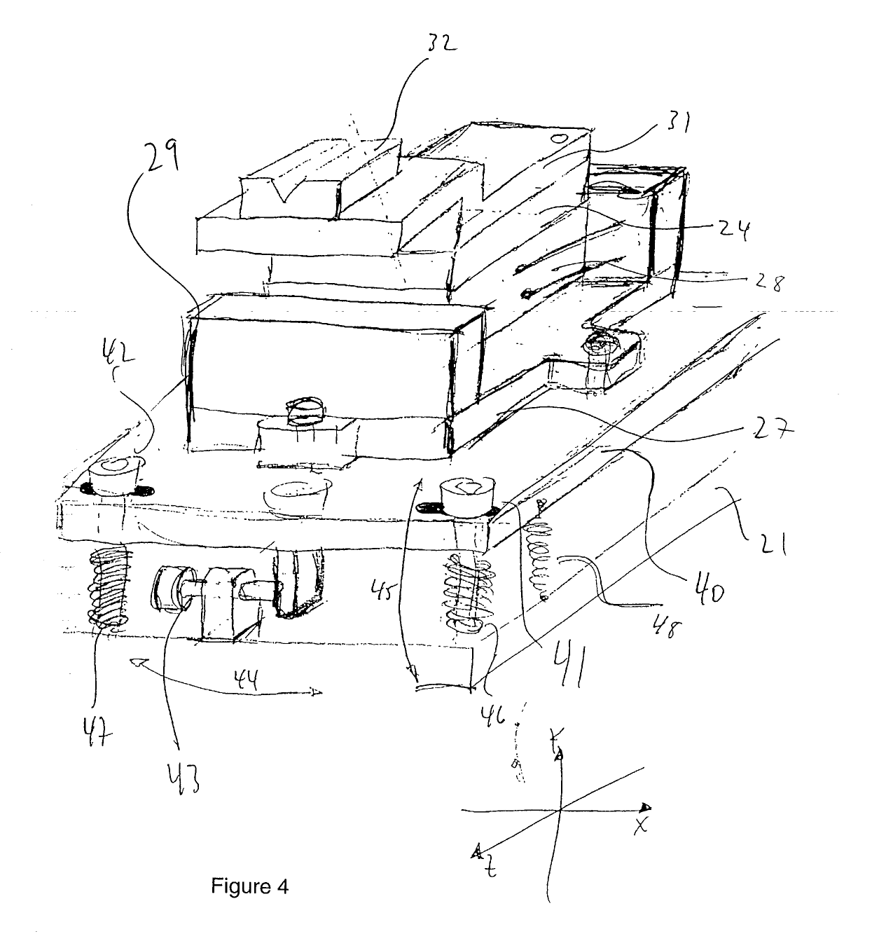

In FIG. 4, the ECM 29 shown is adjustably mounted to a mounting plate 40. The mounting plate 40 is coupled to the slider portion 21 of the linear slider assembly 21, 20 via a three point mounting system. A first mounting point is a pivot point (not shown) that enables pivoting of the ECM 29 about two and optionally three substantially orthogonal axes located at a center of the pivot point. The other three mounting points comprise of a calibration screw 41, 42, and 43 and threaded portion. For calibration screws 41 and 42 a spring is disposed on or about the calibration screws 47 and 46 to bias the mounting plate 40 against the linear slider assembly 21. Rotation of the calibration screws 41 and 42 results in angular movement of the ECM 29 about the first pivot point about at least an axis 45 that is preferably the X axis. Preferably the calibration screws 41 and 42 are adjusted in tandem to prevent rotation of the ECM 29 about the Z axis. Rotating the screw 43 results in angular movement of the ECM 29 about another axis 44, preferably the Y axis. A biasing spring 48 is provided for biasing the mounting plate against calibration screw 43.

In the case in which the optical component is an optical fiber, angular degrees of freedom may need to be fine tuned using the calibration screws 41, 42 and 43, in order to ensure that the optical fibers are substantially parallel with each other. Adding the optical component may cause angular misalignment of the carriage 39 due to the additional weight or due to the orientation the component. Thus, calibration screws are used to position the ECM 29 in such a manner that the controllable electromagnetic axes actuate as desired. In some cases additional flexible mounting is preferably added to aid in supporting the carriage 28 of the ECM 29 to provide additional biasing to the carriage.

Preferably, in use, as the linear actuator 22 moves the ECM 29, mechanical inaccuracies of the linear slide assembly 20 and 21 are actively compensated for by the active control of the ECM 29 in a feedback loop in combination with a control circuit.

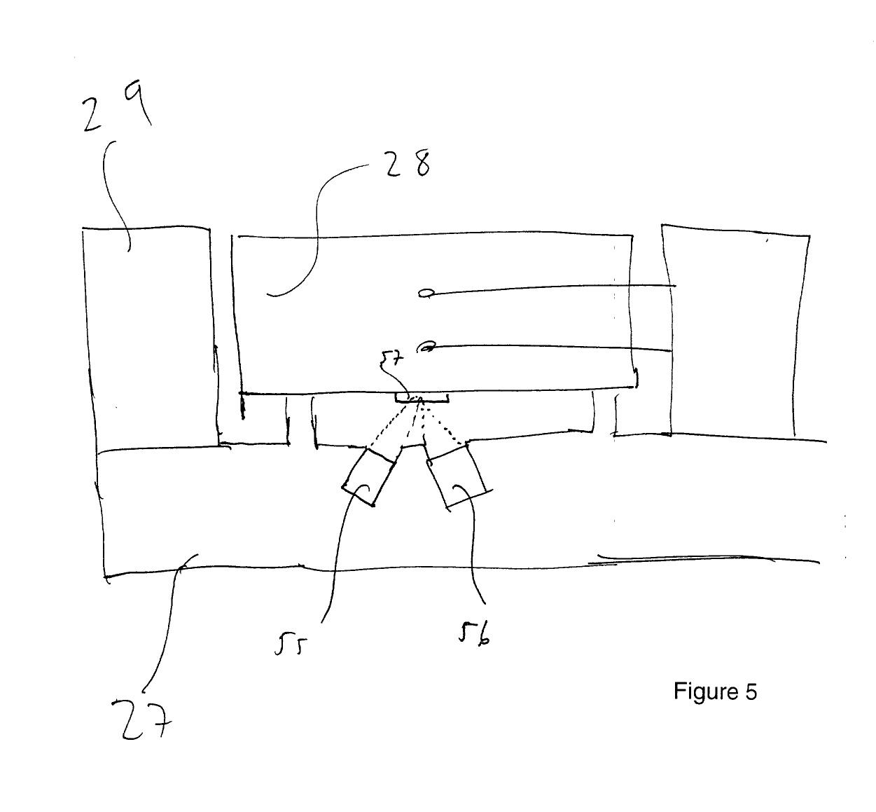

It would be also advantageous to provide an optical feedback assembly for determining the absolute position of the carriage 28 with respect to the stator portion 27. An example of this is shown in FIG. 5. Effects such as vibration may offset the carriage 28 and the absolute position of the component 35. Therefore, having an absolute position feedback mechanism for the carriage 28 would be advantageous. For the absolute position feedback mechanism for the carriage 28 a light source 55, such as an inexpensive diode laser, is thus provided within the ECM 29 to emit light for reflecting off a reflective portion 57 of the carriage 28. A detector 56 embedded within the stator 27 for use in receiving the reflected light from the carriage 28. As the carriage 28 of the ECM 29 moves in relation to the stator 27 of the ECM 29, the intensity of the light impacting the detector varies in an axis in a predetermined manner in dependence upon the position of the carriage 28 relative to the stator portion 27 of the ECM 29. Thus with the use of a calibration table correlating reflected optical intensity to control signal magnitude, the position of the carriage 28 in relation to the optical intensity is determinable. Preferably, such an optical intensity position determining system is provided for sensing the position of the carriage in more than one axis of displacement.

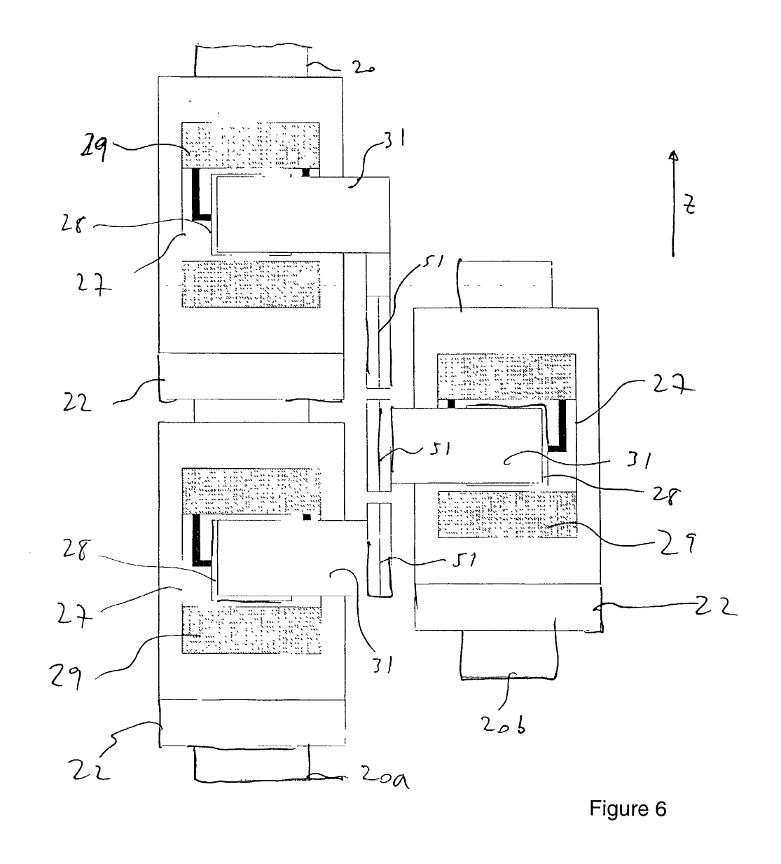

In FIG. 6, a plurality of ECMs 29 are shown, coupled to a same stator portion 20 of a linear actuator bearing slider assembly. Two ECMs are coupled to a same stator portion 20a, and a single ECM is coupled to another same stator portion 20b. Component holders 31 have V-grooves 51 aligned along a common Z axis, with each of the ECMs 29 optionally actuated with respect to the same stator portion 20 using linear motors 29. Preferably, fine adjustment of angular position of the ECMs 29 is performed using the calibration screws prior to use in optical alignment of optical components.

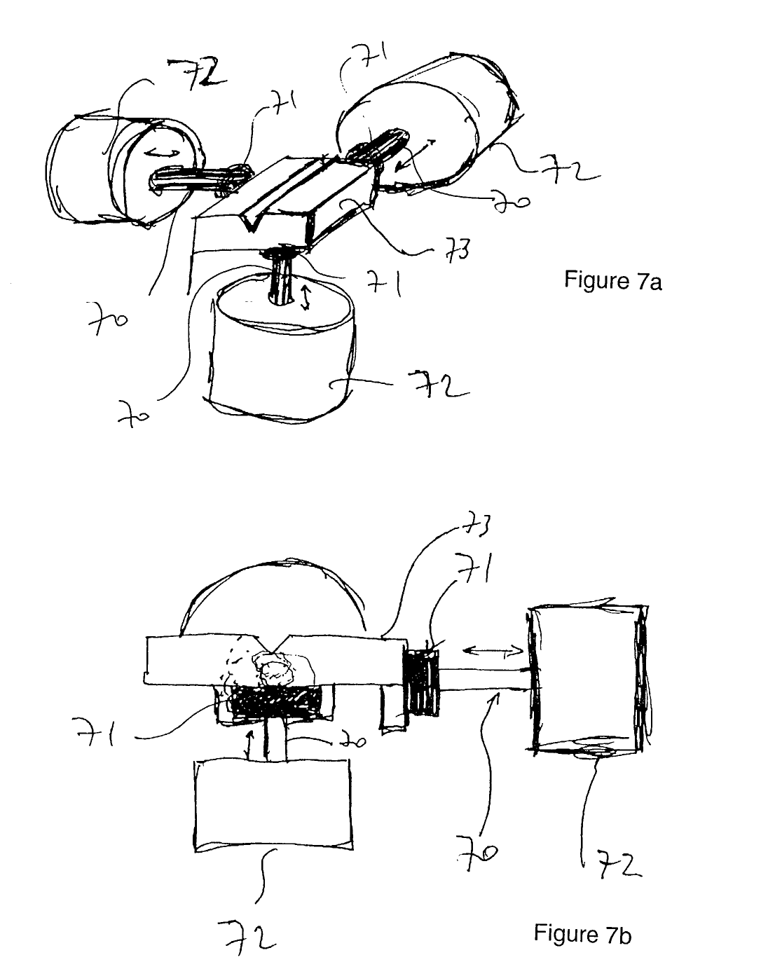

In FIG. 7, an alternate embodiment of the invention is shown using three linear motors 72 having an output shaft 70 of each fixedly coupled to a magnet 71. The three linear motors are preferably oriented orthogonally to each other and mounted to a common mounting plate (not shown). The magnets 71 from all three axes are magnetically attracted to a carriage 73. The carriage 73 is displaced in an axis substantially parallel to the orientation of the linear motor 72 upon the application of a control signal having a magnitude and polarity to the linear motor 72 oriented along that axis. Motion of the carriage 73 along a controlled axis causes the carriage 73 to slide past the magnets 71 of the other stationary axes. Due to the magnetic attraction between the carriage 73, the magnet 71 and the output shaft 70, the carriage 73 is maintained in a substantially parallel orientation to all three axes even during motion of any axis. This arrangement allows for controllable displacement in directions substantially parallel to the three actuated axes without the need for expensive linear slide mechanisms.

The use of an actuator mechanism such as that described herein provides active alignment of components. Because of the dynamic nature of such a system, it allows for compensation of variations in alignment due to temperature changes, epoxy hardening, solder expansion, fusing processes, and other effects resulting during a process of affixing aligned components one to another. Advantageously, such an alignment system thus provides for improved alignment speed as well as significant cost reduction over conventional alignment system designs.

Numerous other embodiments may be envisaged without departing from the spirit or scope of the invention.

What I claim is:

1. A three axis controllable component actuator comprising:
a magnetic stator assembly having permanent magnets disposed therein and having a magnetic yoke assembly with a gap therebetween having magnetic flux therein;
a carriage having electromagnetic coils wound around a first central and around a second central axis, the carriage flexibly mounted to the magnetic stator assembly with a portion of the electromagnetic coils disposed within the gap to permit controllable displacement of the carriage along at lease one of the first and the second axis in response to electric current flowing in the electromagnetic coils interacting with the magnetic flux within the gap; and,
a linear actuator coupled to the magnetic stator assembly for moving the magnetic stator assembly in a substantially orthogonal direction in relation to the first and second axes.

2. A three axis controllable component actuator according to claim 1, wherein the first and the second axis are each substantially orthogonal one to another.

3. A three axis controllable component actuator according to claim 1, comprising at least two flexible members, wherein the carriage is mounted to the stator using the at least two flexible members.

4. A three axis controllable component actuator according to claim 3, wherein the at least two flexible members suspend the carriage for movement within the gap.

5. A three axis controllable component actuator according to claim 1, comprising a component holder for holding the component and for being releasably mounted to the carriage.

6. A three axis controllable component actuator according to claim 5, wherein the component holder has a metallic portion, and where the carriage comprises a magnet embedded within an upper portion of the carriage, opposite the magnetic stator assembly, the magnet for magnetically attracting the metallic portion of the component holder for facilitating releasable mounting of the component holder.

7. A three axis controllable component actuator according to claim 1, comprising:
a light source for providing light;
a reflective portion for receiving light from the light source and for providing reflected light;
a detector for receiving the reflected light from the reflective portion and for providing a feedback signal, the reflective portion fixed to the carriage for being displaced with the carriage causing an optical power variation detected on the detector in response thereto; and,
a control circuit for receiving the feedback signal and for providing a control signal to at least one of the linear-actuator and the electromagnetic coils in response thereto.

8. A three axis controllable component actuator according to claim 7, wherein the control circuit comprises a lookup table for storing a relationship between the magnitude and the polarity of the control signal and the feedback signal.

9. A three axis controllable component actuator according to claim 1 wherein the component is an optical component.

10. A component actuator comprising:
a first linear actuator having a first stator and a first actuatable shaft, the first actuatable shaft for being displaced in a direction along a first axis and with a distance in proportion to a first control signal having a polarity and a magnitude and applied to the first linear actuator;
a first magnet coupled to the first actuatable shaft; and,
a carriage magnetically coupled to the first magnet and other than fixedly coupled to the first linear actuator, for, in use, moving along an axis substantially parallel to the first axis in dependence upon the first control signal.

11. A component actuator according to claim 10, comprising:
a second linear actuator having a second stator coupled to the first stator and a second actuatable shaft, the second actuatable shaft for being displaced in a direction along a second axis and with a distance in proportion to a second control signal having a polarity and a magnitude and applied to the second linear actuator;
a first magnet coupled to the second actuatable shaft; and,
a carriage magnetically coupled to the second magnet and other than fixedly coupled to the second linear actuator, for, in use, moving along an axis substantially parallel to the second axis in dependence upon the second control signal.

12. A component actuator according to claim 11, comprising:
a third linear actuator having a third stator coupled to the first stator and the second stator and a third actuatable shaft, the third actuatable shaft for being displaced in a direction along a third axis and with a distance in proportion to a third control signal having a polarity and a magnitude and applied to the third linear actuator;
a first magnet coupled to the third actuatable shaft; and,
a carriage magnetically coupled to the third magnet and other than fixedly coupled to the third linear actuator, for, in use, moving along an axis substantially parallel to the third axis in dependence upon the third control signal.

13. A component actuator according to claim 11, wherein the first and the second axes are substantially orthogonal one to another.

14. A component actuator according to claim 13, wherein the third axis is substantially orthogonal to the first and the second axes.

15. A component actuator according to claim 13 comprising a component holder for holding the component and for being releasably mounted to the carriage.

16. A component actuator according to claim 14 wherein the carriage comprises comprising a control circuit, the control circuit for providing at least one of the first control signal and second control signal and third control signal.

17. A component actuator according to claim 10 wherein the component is an optical component.
